(19) United States
(12) Patent Application Publication
(10) Pub. No.: US 2013/0191175 A1
(43) Pub. Date: Jul. 25, 2013

(54) PERSONNEL ACTIVITY RECORDING TERMINAL, PERSONNEL MANAGEMENT SYSTEM AND METHOD FOR CONTROLLING SUCH A SYSTEM

(71) Applicants: Crichton Miller, Rugby (GB); Fiona McMillan, Rugby (GB); Daniel Ross, Nuneaton (GB)

(72) Inventors: Crichton Miller, Rugby (GB); Fiona McMillan, Rugby (GB); Daniel Ross, Nuneaton (GB)

(73) Assignee: Haul-It Nationwide Limited, Rugby (GB)

(21) Appl. No.: 13/748,691

(22) Filed: Jan. 24, 2013

(30) Foreign Application Priority Data
Jan. 25, 2012 (GB) GB1201251.4

(51) Int. Cl. G06Q 10/06; G06K 5/00

(52) U.S. Cl. CPC G06Q 10/063114; G06K 5/00
USPC 705/7.15; 235/380

(57) ABSTRACT

A personnel management system includes a personnel activity recording terminal, a subscriber terminal for receiving subscriber assignments, a server for receiving data from the personnel activity recording terminal and the subscriber terminal, and a database for storing the data received at the server. The server is arranged to compare the data received from the personnel activity recording terminal and the subscriber assignments and to allocate assignments to personnel.

### CROSS-REFERENCE TO RELATED APPLICATIONS

This application claims priority from UK Patent Application GB1201251.4, filed 25 Jan. 2012.

### FIELD OF THE INVENTION

This invention relates to a personnel activity recording terminal, personnel management system and method for controlling such a system. In particular, this invention relates to a haulage personnel activity recording and management system.

### BACKGROUND OF THE INVENTION

Many employers wish to record the attendance of personnel, such as employees and contractors, who undertake assignments on their behalf. Time and attendance readers are commonly used for this task. Such readers are typically located at entrances to sites of work and personnel are required to register their entry and exit from such sites, commonly known as “clocking in/out” or “checking in/out”.

Once data has been entered at the time and attendance reader, it is recorded in a database residing in the system. The data is accessible to resource planning and allocation modules, including personnel planning and allocation modules, which form a part of the system.

Such systems comprise a number of functional blocks which use the data that has been recorded in the database. For example, a payroll system uses the data to calculate salaries (including overtime payments) or payments to contractors or agencies. An invoicing module uses the data to generate invoices to customers. A resource planning and allocation module uses the data to allocate/match assignments to operatives who are available for work.

Regarding resource planning, whether or not a particular operative is available for an assignment will depend on a number of factors. For example, the new assignment may require an operative with a certain skill set, in which case the system will only identify suitable candidates who have the requisite skills. The new assignment will take a certain amount of time to complete, therefore the system will only identify those candidates who have sufficient hours remaining in their working day or who agree to work a certain amount of overtime.

This latter issue may be affected by local statutory requirements. For example, in the transport industry, local law stipulates that drivers may only drive for a certain number of hours before taking a break of a specified time, which may invalidate some drivers for new assignments.

This invention provides an improved resource recording apparatus, resource management system and method for controlling such a system.

### SUMMARY OF THE INVENTION

According to a first aspect of the invention there is provided a personnel activity recording terminal comprising: a reader for reading data stored in a carrier medium, the carrier medium being uniquely associated with a person; a display for displaying information to the person; a camera for viewing the person; a microphone and speaker for verbally communicating with the person; a keypad; a controller which is operatively connected to each of the reader, display, keypad, camera, microphone, speaker and keypad and which is arranged to generate an authentication token based on the information stored in the carrier medium; and an electronic communication module connected to the controller.

The reader may be one of a: a biometric scanner, a radio-frequency identification, RFID, reader; a near field communication, NFC, reader; a Bluetooth transceiver; a code scanner; and a WiFi transceiver.

The reader may be a smart card reader and the carrier medium a smart card.

The person may be a driver and the smart card a digital tachograph. In particular, the driver may be a haulage driver.

The smart card reader may be arranged to read data from the digital tachograph relating to the activities of the person.

The data which is read from the digital tachograph may include: activity of the driver (e.g., times when the driver rested, drove and had a break), the total mileage driven each day, the registration number of any vehicles driven by the driver, the driver's driving license number, the identification number of the digital tachograph smartcard and the forename, surname and date of birth of the smartcard holder.

The terminal may further comprise a biometric information reader for identifying and authenticating the person. The biometric information reader may be arranged to read one or more of: a fingerprint, a facial pattern, a palm print, and iris/retina recognition.

The key pad may be a numeric or an alphanumeric keypad. The key pad may be a touch screen of the display device.

According to a second aspect of the invention there is provided a personnel management system comprising: a personnel activity recording terminal as defined above; a subscriber terminal for receiving subscriber assignments; a server for receiving data from the personnel activity recording terminal and the subscriber terminal; and a database for storing the data received at the server, wherein the server is arranged to compare the data received from the personnel activity recording terminal and the subscriber assignments and to allocate assignments to personnel.

The allocation of assignments to personnel may be based on one or more of: aspects of the assignment; EU Driver Hours rules; Working Time Rules; health and Safety inductions; client bans or suspension; a maximum number of lates or no-shows; and required qualifications.

The personnel activity recording terminal may be arranged to send data to the server when an authentication token is generated in the personnel activity recording terminal, the data comprising the authentication token and data read by the reader from the carrier medium.

The server may be arranged to send personalised data to the personnel activity recording terminal when the authentication token is received from the personnel activity recording terminal.

The personalised data may comprise one or more of: a message, a video call request and assignment instructions.

According to a further aspect of the invention, a method of managing personnel, comprises: receiving a carrier medium at a personnel activity recording terminal as defined in any one of claims 1 to 11, the carrier medium being uniquely associated with a person; reading authentication data and activity data stored in the carrier medium; generating an authentication token based on the data read from the carrier medium; transmitting the authentication token and the activity data to a server; storing the data in a database; receiving subscriber assignments at a subscriber terminal; transmitting the subscriber assignments to the server; storing the subscriber assignments in the or another database; wherein following receipt of the authentication token and activity data the server is arranged to compare the data received from the personnel activity recording terminal and the subscriber assignments and to allocate assignments to personnel based on predetermined criteria.

The predetermined criteria may include one or more of: aspects of the assignment; Agency Worker Regulations, tracking of the individual across multi sites for calculating variable pay parity, Swedish Derogation or pay between assignments, EU Driver Hours rules; Working Time Rules; Health and Safety inductions; client bans or suspension; a maximum number of, lates or no-shows; fuel economy performance; required qualifications; periodic licence checks; periodic assessments; automated transmission by text or e mail of the contract and Health and Safety rules associated with that assignment.

The method may further comprise undertaking an interview with the person.

According to a further aspect of the invention there is provided a carrier medium carrying computer readable code for controlling a microprocessor to carry out the method described above.

The present invention can be implemented in any convenient form, for example using dedicated hardware, or a mixture of dedicated hardware and software. The present invention may be implemented as computer software implemented by one or more networked processing apparatuses. The network can comprise any conventional terrestrial or wireless communications network, such as the Internet. The processing apparatuses can comprise any suitably programmed apparatuses such as a general purpose computer, personal digital assistant, mobile telephone (such as a WAP or 3G-compliant phone) and so on. Since the present invention can be implemented as software, each and every aspect of the present invention thus encompasses computer software implementable on a programmable device. The computer software can be provided to the programmable device using any conventional carrier medium. The carrier medium can comprise a transient carrier medium such as an electrical, optical, microwave, acoustic or radio frequency signal carrying the computer code. An example of such a transient medium is a TCP/IP signal carrying computer code over an IP network, such as the Internet. The carrier medium can also comprise a storage medium for storing processor readable code such as a floppy disk, hard disk, CD ROM, magnetic tape device or solid state memory device.

### BRIEF DESCRIPTION OF THE DRAWINGS

The invention will be further described by way of example with reference to the accompanying drawings in which:

FIG. 1 is a block diagram schematically illustrating a personnel management system forming an embodiment of the invention;

FIG. 2 is a block diagram of a personnel activity recording terminal of the system of FIG. 1;

FIG. 3 is a flowchart showing a boot-up process undertaken in the personnel activity recording terminal of FIG. 1; and

FIG. 4 is a flowchart showing a process for transferring data between the personnel activity recording terminal, a server and a database of the system of FIG. 1.

### DETAILED DESCRIPTION OF EMBODIMENTS

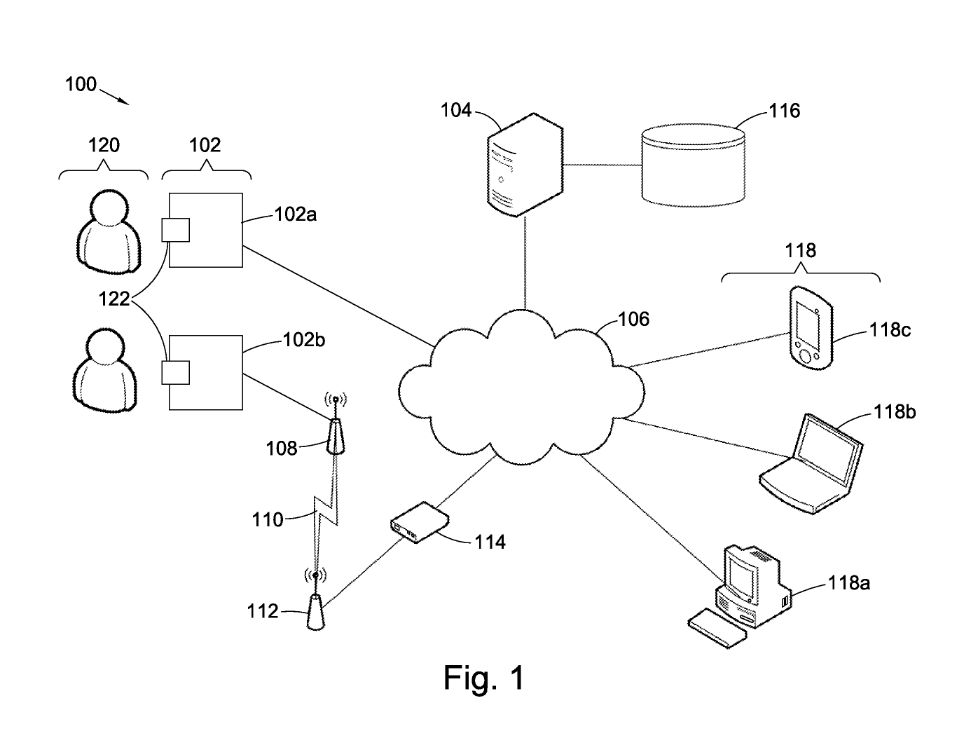

FIG. 1 is a block diagram schematically illustrating a personnel management system 100 forming an embodiment of the invention.

The personnel management system 100 shown in FIG. 1 is used to manage the assignments/tasks/activities of haulage drivers. Such drivers are allocated assignments, such as transporting a load from a first site to a second site, where the load is to be unloaded. Though the specific embodiment shown in the Figures relates to a haulage management system, the skilled person will appreciate that the management system shown in the Figures can be applied to any personnel management system in any area of commerce.

Personnel management system 100 comprises a plurality of personnel activity recording terminals 102 and a server 104. The personnel activity recording terminals 102 are connected to the server 104 via a network, such as the Internet 106. Two personnel activity recording terminals 102A, 102B are shown in FIG. 1 but a personnel management system 100 may comprises dozens or even hundreds of personnel activity recording terminals 102.

The first personnel activity recording terminal 102A is connected to the Internet 106 by a wired connection. The second personnel activity recording terminal 102B is connected to the Internet 106 as follows. The second personnel activity recording terminal 102B is connected by a wired connection to a first base station 108. The first base station 108 connects via a wireless connection/link 110 to a second base station 112. The second base station 112 connects to the Internet 106 via a modem 114. The second base station 112 and the modem 114 may be incorporated in a single casing as a wireless router access point. The wireless connection 110 between the first base station 108 and the second base station 112 is a WiFi® connection. The wireless link 110 may be another type of wireless connection, such as a cellular connection or Bluetooth® wireless link.

The personnel activity recording terminals 102 are located at distribution depots. The first personnel activity recording terminal 102A is located at a different distribution depot to the second personnel activity recording terminal 102B. However, both personnel activity recording terminals 102A, 102B may be located at the same distribution depot, for example where the depot is large. The skilled person in the art will appreciate that where the personnel management system 100 is applied to an area of commerce other than haulage then the personnel activity recording terminals 102 will be located at sites other than haulage distribution depots.

The server 104 is connected to a database 116 via a wired connection. It will be appreciated that the whilst the database 116 is shown as being separate from the server 104, in other embodiments the database 116 may form part of the server 104. Alternatively, the database 116 may be at a location which is remote from the server 104.

The personnel management system 100 comprises a plurality of subscriber terminals 118. The subscriber terminals 118 may be a general purpose computer 118A, a laptop 118B, a personal digital assistant (PDA) 118C or any other device that can be used by a subscriber to input haulage assignment requests into the personnel management system 100. The subscriber terminals 118 are connected to the server 114 via the Internet 116. The subscriber terminals 118 are shown as being connected to the Internet via a wired connection. It will be appreciated by the skilled person that the subscriber terminals 118 may alternatively be connected to the Internet via a wireless link. It will also be appreciated that the subscriber terminals 118 may be directly connected to the server 104.

Haulage assignment requests are entered at a subscriber terminal 118 by a subscriber/client/commissioner/agency/employer and are transmitted via the Internet 106 to the server 104 and subsequently stored in the database 116. It will be appreciated that where the personnel management system 100 is used for areas of commerce other than haulage then the requests entered at the subscriber terminals 118 will not be haulage assignment requests but will be other types of work requests.

Haulage drivers 120 interact with the personnel management system 100 after inserting a digital tachograph card 122 into a personnel activity recording terminal 102. Further details of this process are provided below.

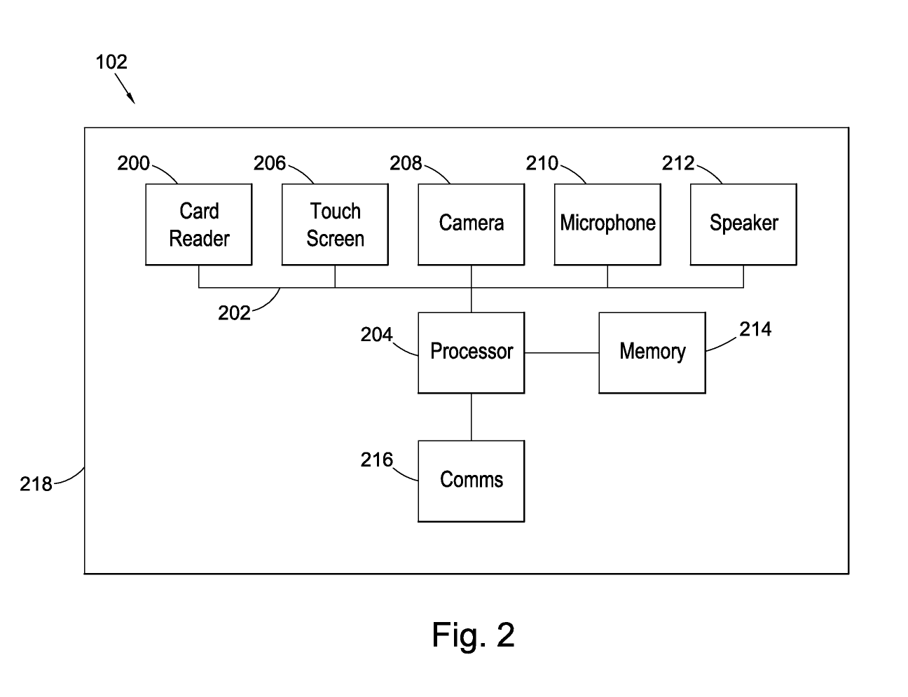

FIG. 2 is a block diagram of a personnel activity recording terminal 102 as shown in FIG. 1. The personnel activity recording terminal 102 comprises a card reader 200, which receives and reads the digital tachograph smart card 122 shown in FIG. 1. The card reader 200 is connected via a bus 202 to a processor 204. The personnel activity recording terminal 102 also comprises a touch screen 206, a camera 208, a microphone 210 and a speaker 212, each of which is connected via the bus 202 to the processor 204. A memory 214 is provided and is operatively connected to the processor 204. The memory 214 may comprise one or both of volatile and non-volatile memory and stores an operating system used by the processor 204, as well as data which is received from and sent to the smart card 122 and the server 104. The personnel activity recording terminal 102 further comprises a communications module 216 which is operatively connected to the processor 204. The communications module 216 enables the personnel activity recording terminal 102 to communicate with other devices, such as base station 108 and server 104 as shown in FIG. 1. Alternatively, the communications module 216 may incorporate the base station 108 of FIG. 1. The touch screen 206, camera 208, microphone 210, speaker 212, processor 204, memory 214 and communications module 216 may form part of a single device, such as a tablet computer. All of the above components of the personnel activity recording terminal 102 are housed within a housing 218.

The touch screen 208 is arranged to display messages and instructions to drivers 120. The touch screen 208 also acts as a user interface for drivers 120 to input data into the system 100 and to provide acknowledgements, as is explained below. Camera 208, microphone 210 and speaker 212 allow the drivers 120 to communicate by videoconference to another party using the system 100, such as an employer, manager or subscriber. If teleconferencing is required then the microphone 210 and speaker 212 alone are used for this purpose.

As stated above, the card reader 200 is used to read data stored in a digital tachograph smart card 112 belonging to a driver 120 and to identify the driver. As will be readily apparent, other types of carrier medium can be used to identify the driver/operative and to store pertinent information which is to be input by the person using the personnel activity recording terminal 102. For example, instead of or in addition to a card reader 200 the personnel activity recording terminal 102 may include a radio frequency identification (RFID) reader, a near field communication (NFC) reader, a Bluetooth® transceiver, a code scanner, a WiFi® transceiver or any other device for receiving data from a haulage driver 120 or other worker.

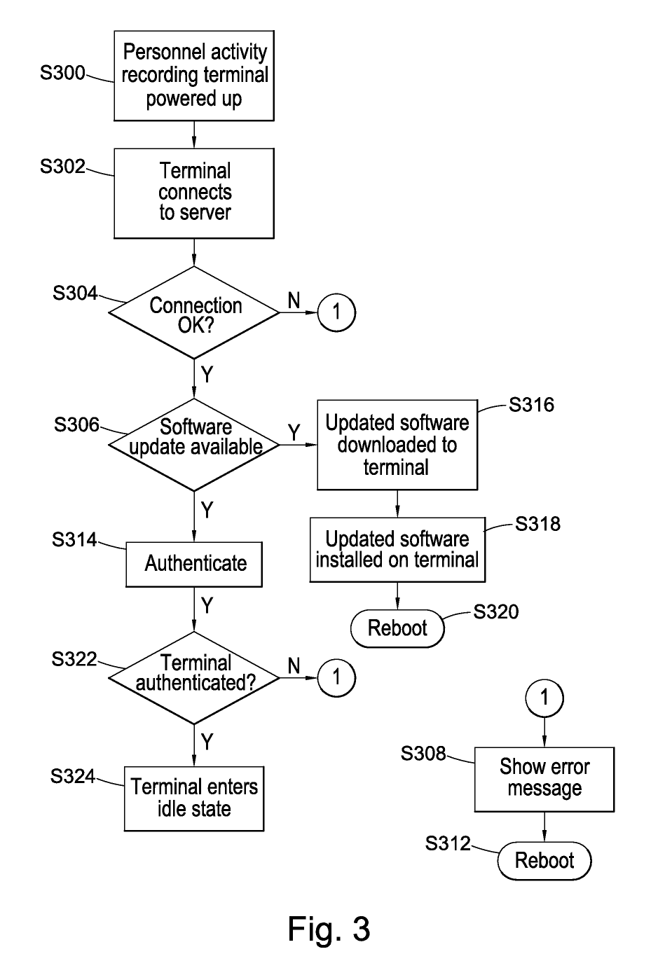

FIG. 3 is a flowchart showing the steps undertaken when the personnel activity recording terminal 102 is powered up.

At step S300, the personnel activity recording terminal 102 is powered up. The personnel activity recording terminal 102 boots up and performs a self-check, after which at step S302 the terminal 102 connects via the Internet 106 to the server 104. If the terminal 102 connects to the server 104 at step S304 then the terminal 102 checks with the server 104 if a software update is available, at step S306. Otherwise, the terminal proceeds to step S308 where an error message is displayed on the terminal at step S310 and the terminal 102 reboots at step S312.

If a software update is required then at step S316 the software is downloaded from the server 104 via the internet 106 to the personnel activity recording terminal 102. The latest version of the software may be stored in the database 116 which is operatively connected to the server 104. Once the latest version of software has been downloaded from the server 104 to the personnel activity recording terminal 102, the updated software is installed on the terminal 102 at step S318. Once the updated software has been installed on the terminal, the process proceeds to step S320 where the terminal 102 reboots.

If the software in the personnel activity recording terminal is up to date then the process proceeds to step S314 where the terminal 102 is authenticated by the server 104. If the authentication is successful then the process proceeds from step S322 to S324, where the terminal 102 enters an idle state. If the terminal 102 is not authenticated by the server 104 then an error message is displayed at step S308 and the terminal 102 reboots at step S312.

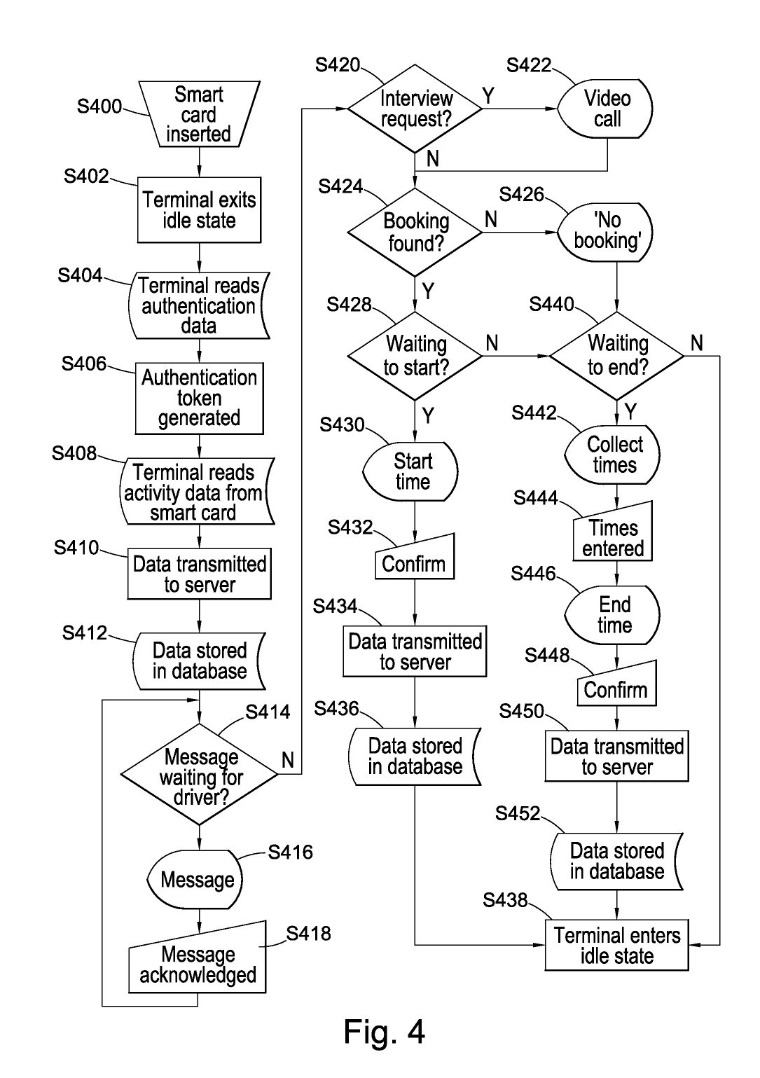

FIG. 4 is a flowchart showing the interactions of a driver 120 (or other operative) with the personnel activity recording terminal 102.

At step S400 a smartcard 122 is inserted into the card reader 200 of the personnel activity recording terminal 102. By inserting the smartcard 122 the terminal 102 exits the idle state at step S402. The terminal 102 then reads the authentication data stored in the smartcard 122 at step S404 and generates an authentication token at step S406. The authentication token is a stream of data which uniquely identifies a person (driver) for the purposes of data retrieval.

Once the authentication token has been generated, the terminal reads the data stored in the smartcard at step S408. Alternatively, the steps of S404 and S408 may be combined, so that the personnel activity recording terminal 102 reads both the authentication data and the activity data stored in the smartcard 122 at the same time.

Activity data stored in the digital tachograph card may include one or more of the activity of the driver (e.g., times when the driver rested, drove and had a break), the total mileage driven each day, the registration number of any vehicles driven by the driver, the driver's driving license number, the identification number of the digital tachograph smartcard and the forename, surname and date of birth of the smartcard 112 holder. One or more of these pieces of information, such as the name of the driver and his driving license number, can be used to identify the driver to whom the digital tachograph smartcard 122 belongs. Once the personnel activity recording terminal 102 has generated the authentication token and captured the activity data for the driver, this data is sent to the server 104 via the Internet 106 at step S410. Once received at the server 104, the activity data is stored in the database 116 at step S412.

Once the driver's identity has been verified by the server 104, the server 104 checks the database 116 to enquire if there is a message waiting for the driver 120 at step S414. If there is a message waiting for the driver then the message is downloaded from the server 104 to the personnel activity recording terminal 102 and displayed on the touch screen 206 of the terminal 102 at step S416. The message may include information relevant to the driver, such as instructions, warnings, network news (e.g., roadworks), weather updates or other relevant information. After the message has been displayed, the terminal 102 prompts the driver 120 to acknowledge that the message has been read and the driver 120 does so by pressing a button on the touch screen 206 at step S418.

Once the message has been displayed to and confirmed by the driver 120, the process returns to step S414 to check if there are any further messages waiting for the driver 120. Once all messages have been displayed to the driver 120, the server 104 checks if there is an interview request for the driver 120 at step S420. If there is a pending interview request then the driver is prompted to undertake a video call with the relevant individual at step S422. During the video call, the driver 120 communicates with the other party using the camera 208, microphone 220 and speaker 212, whilst the other party's picture is optionally displayed on the touch screen 206. If there are a number of interview requests pending on the system 100 then steps S420 and S422 are repeated until all requests have been satisfied.

A subscriber, employer, manager or operator may request an interview with a driver on one of a number of different occasions. For example, a party may wish to undertake an interview with a driver when one of the normal rules of the driver's operation has been infringed. These rules may be as set out in the Drivers' Hours legislation or may be working rules which are laid down by the driver's employer or contracting party. By incorporating a camera 208, microphone 210, and speaker 212, an interested party is able to communicate by videoconference with a driver 120, which provides significant advantages and efficiencies to operators of such systems 100 since any issues which need to be discussed face-to-face can be done by using the videoconference functionality available in the personnel activity recording terminal 102.

Once all interviews have been conducted then at step S424 the server 104 checks if there are any bookings for the driver 120. If there are no bookings then the process proceeds to step S426 where this is communicated to the driver 120 via the touch screen 206.

If there are bookings waiting for the driver 120 then at step S428 the server 104 determines whether the driver 120 is waiting to start a shift. If the driver is waiting to start a shift then the driver is prompted at step S430 to input the start time of his shift and once done this is confirmed at step S432. For example, it may be the case that there was a delay between when the driver entered the depot and when the driver was able to insert the smartcard 122 into the personnel activity recording terminal 102 and this discrepancy can be corrected at this time. The entered data is transmitted to the server 104 at step S434 and stored in the database 116 at step S436 and the terminal 102 enters an idle state at step S438.

If at step S428 the server 104 determines that the driver is not waiting to start a shift then the server checks at step S440 whether the driver is waiting to end a shift. If the driver is waiting to end a shift then a message is displayed on the touch screen 206 at step S442 to prompt the driver 120 to input, via the touch screen 206, any break times which the driver has taken, and the driver does this at step S444. The break times are entered by the driver so that the system 100 can calculate the number of hours during which the driver was actually driving. This amount of time is used to calculate the driver's eligibility for further work later on.

Once the break times have been entered at step S444, the driver enters the end time of his shift at step S446. As with the driver entering the start time of the shift, it may be the case that there was a delay as the driver arrived at the depot, which resulted in the driver arriving at the personnel activity recording terminal 102 at a time which was later than the time at which the driver had actually completed his shift. Once the data has been entered and confirmed at step S448, the entered data is transmitted to the server 104 at step S4550 and stored in the database 116 at step S452 and the terminal 102 enters an idle state at step S438 and remains in that state until the digital tachograph smartcard 122 of a further driver 120 is inserted into the smartcard reader 200 of the personnel activity recording terminal 122.

Once the server 104 and database 116 have collated all relevant information about a particular driver 120 from his/her digital tachograph smartcard 122, work assignments can be assigned to the driver 120. The work assignments may be for the driver's next shift or for any remaining time left on the driver's current shift. The calculation of suitable assignments may be met based on a number of factors, including one or more of:
aspects of the assignment;
EU Driver Hours rules;
Working Time Rules;
The appropriate driving licence of the operative;
Health and Safety inductions;
Client bans or suspension;
A maximum number of lates or no-shows; and
Required qualifications, or other relevant factors.

As well as the personnel activity recording terminal 102 reading data stored in the smartcard 122 and sending this data to the server 104, the terminal 102 also sends data to the server 104 relating to the personnel activity recording terminal 102. For example, identification data relating to the terminal 102, for example associated with the physical location of the terminal 102, and timing information of the user's interaction with the terminal 102. This information can be used to determine the physical location of drivers 120.

The data stored in the database 116 about the driver's 120 activities can be used to analyse the activities of the driver 120. For example, the data can be used to check that a driver's activities conform to the Driver Hours rules or to check for any possible infringement of the rules.

Various modifications will be apparent to those in the art and it is desired to include all such modifications as fall within the scope of the accompanying claims.

For example, in addition to the camera 208 being used to videoconference with a driver 120, the camera 208 can also be used to capture data which would be of interest. For example, the camera 208 can be used to photograph a proof-of-delivery associated with an assignment, and any relevant documentation issued for an assignment, or even a photo of the driver 120 themselves.

In the embodiment described above, the identity of a driver 120 is established by using the driver's digital tachograph smartcard 122. In addition to or as an alternative to using the driver's smart digital tachograph smartcard 122, further methods of uniquely identifying a driver can be used. For example, biometric data of a driver 120 can be used to uniquely identify the driver. The biometric data may be fingerprints, iris recognition, palm recognition or a voice print of the driver. In order to use these alternative driver authentication tools, the personnel activity recording terminal 102 may comprise further readers, such as a fingerprint reader or dedicated biometric data reader. For certain types of biometric data entry, it is not necessary to incorporate further hardware items into the terminal 102. Rather, these can be implemented in software using the components described above. For example, voice recognition software can be implemented using software, without any further hardware requirements. Similarly, since the terminal 102 already incorporates a camera 208, software can be used to process any captured images of a user's face to implement facial recognition.

A further method of a driver 120 identifying and authenticating him/herself to the system 100 is by use of a password or pin number. These can be entered by means of the touch screen 206 or via a dedicated keypad (not shown). If the driver or other operative wishes to enter any notes into the system 100, then these can be done by typing them on the touch screen 206 or keypad or by dictating them via the microphone 210. If the notes and comments are dictated then they can either be transmitted to the server 104 as a sound file or they can be converted into text by utilising speech recognition software in the terminal 102.

When using alternative identification and/or authentication methods, it should be borne in mind that different devices have varying levels of security and the appropriate device should be chosen to match the desired level of security.

The personnel activity recording terminal 102 described above uses a card reader 200 to read information stored in the digital tachograph smartcard 122. As stated above, the terminal 102 can be adapted to obtain data stored in other recording media in addition to or as an alternative to the smartcard 122 recording medium. Examples of such recording media are text, mobile phones, laptops, smart devices and examples of data transfer protocols are RFID, NFC, Bluetooth® and WiFi®.

The system 100 can be further adapted to offer future work assignments to a driver 120 or other operative. Whether this work is at the current client's site or at a related or different depot or client, such assignment offers can be determined based on a number of factors as described above. The terminal 102 can be used to record an acceptance or rejection by the driver 120 of such further offers.

In addition, the driver can use the terminal 120 to update their personal details, such as their address, phone number(s), email address(es) or other contact details. The touch screen 206 of the terminal 102 can be used to present information to the driver such as their pay slips, pay estimates, automated employment references, their current ratings and other useful information such as tips to improve their performance. As will be apparent to the skilled person, providing the terminal 102 with tele- and videoconference functionality greatly improves its utility and allows managers and employers of personnel to easily interact with personnel who are remote. It is particularly convenient to have these functionalities in the smartbox 102 for haulage or other drivers who typically only spend short periods of time at a worksite, since contacting drivers whilst they are driving is dangerous and is illegal in certain jurisdictions. Consequently, using the terminal 102 to contact the drivers once they are stationary is ideal. The touch screen 206 described above can be replaced by a non-touch screen and a separate input device such as a keyboard.

It will be readily apparent to the skilled person that the system 100 described herein can be applied to areas of activity other than haulage, such as medical professionals, factory and retail workers, public transport staff, hotel staff, security guards or any other type of shift or fixed-hours paid or voluntary work.

1. A personnel activity recording terminal comprising:
a digital tachograph reader for reading data stored in a digital tachograph uniquely associated with a haulage driver;
a display for displaying information to said haulage driver;
a camera for viewing said haulage driver;
a microphone and speaker for verbally communicating with said driver;
a keypad;
a controller which is operatively connected to each of the reader, display, keypad, camera, microphone, speaker and keypad and which is arranged to generate an authentication token based on the information stored in said digital tachograph; and
an electronic communication module connected to the controller.

2. A terminal as claimed in claim 1, wherein the digital tachograph reader is arranged to read data from the digital tachograph relating to the activities of said driver.

3. A terminal as claimed in claim 2, wherein the data which is read from the digital tachograph comprises at least one of activity of the driver, total mileage driven each day, registration number of any vehicles driven by the driver, the driver's driving license number, identification number of a digital tachograph smartcard and a forename, surname and date of birth of a holder of the smartcard.

4. A terminal as claimed in claim 1, further comprising a biometric information reader for identifying and authenticating the driver.

5. A terminal as claimed in claim 4, wherein the biometric information reader is arranged to read one or more of:
a fingerprint,
a facial pattern,
a palm print, and
iris/retina recognition.

6. A terminal as claimed in claim 1, wherein the key pad is a numeric or an alphanumeric keypad.

7. A terminal as claimed in claim 1, wherein the key pad is a touch screen of the display device.

8. A personnel management system comprising:
a personnel activity recording terminal as defined in claim 1;
a subscriber terminal for receiving subscriber assignments;
a server for receiving data from the personnel activity recording terminal and the subscriber terminal; and
a database for storing the data received at the server,
wherein the server is arranged to compare the data received from the personnel activity recording terminal and the subscriber assignments and to allocate assignments to personnel.

9. A personnel management system as claimed in claim 8, wherein the allocation of assignments to personnel is based on one or more of: aspects of the assignment; EU Driver Hours rules; Working Time Rules; health and Safety inductions; client bans or suspension; a maximum number of lates or no-shows; and required qualifications.

10. A personnel management system as claimed in claim 8, wherein the personnel activity recording terminal is arranged to send data to the server when an authentication token is generated in the personnel activity recording terminal, the data comprising the authentication token and data read by the reader from the carrier medium.

11. A personnel management system as claimed in claim 8, wherein the server is arranged to send personalised data to the personnel activity recording terminal when the authentication token is received from the personnel activity recording terminal.

12. A personnel management system as claimed in claim 11, wherein the personalised data comprise one or more of: a message, a video call request and assignment instructions.

13. A method of managing personnel, comprising:
receiving a digital tachograph at a personnel activity recording terminal as defined in claim 1, the digital tachograph being uniquely associated with a haulage driver;
reading authentication data and activity data stored in said digital tachograph;
generating an authentication token based on the data read from said digital tachograph;
transmitting the authentication token and the activity data to a server;
storing the data in a database;
receiving subscriber assignments at a subscriber terminal;
transmitting the subscriber assignments to the server;
storing the subscriber assignments in the or another database;
wherein following receipt of the authentication token and activity data the server is arranged to compare the data received from the personnel activity recording terminal and the subscriber assignments and to allocate assignments to personnel based on predetermined criteria.

14. A method as claimed in claim 13, wherein the predetermined criteria include one or more of: aspects of the assignment; Agency Worker Regulations, tracking of the individual across multi sites for calculating variable pay parity, Swedish Derogation or pay between assignments, EU Driver Hours rules; Working Time Rules; Health and Safety inductions; client bans or suspension; a maximum number of, lates or no-shows; fuel economy performance; required qualifications; periodic licence checks; periodic assessments; automated transmission by text or e mail of the contract and Health and Safety rules associated with that assignment.

15. A method as claimed in claim 13, further comprising undertaking an interview with the driver.
